(19) United States
(12) Patent Application Publication
(10) Pub. No.: US 2014/0238236 A1
(43) Pub. Date: Aug. 28, 2014

(54) COGENERATION SYSTEM CONCEPT FOR CO2 RECOVERY PLANT

(71) Applicant: MITSUBISHI HEAVY INDUSTRIES, LTD., Tokyo (JP)

(72) Inventors: Masayuki Inui, Austin, TX (US); Takahito Yonekawa, Austin, TX (US); Tiffany Wu, Austin, TX (US); Tatsuya Tsujiuchi, Austin, TX (US); Shintaro Honjo, Austin, TX (US); Koji Nakayama, Hiroshima-shi (JP)

(73) Assignee: MITSUBISHI HEAVY INDUSTRIES, LTD., Tokyo (JP)

(21) Appl. No.: 13/775,464

(22) Filed: Feb. 25, 2013

(51) Int. Cl. B01D 53/14

(52) U.S. Cl. CPC B01D 53/1425; B01D 53/1475
USPC 95/173; 96/242

(57) ABSTRACT

A CO₂ recovery system and a CO₂ recovery method include an absorption apparatus that causes CO₂ in an exhaust gas to be absorbed by CO₂ absorption liquid, a regeneration apparatus that heats the CO₂ absorption liquid to separate CO₂; a CO₂ compression mechanism of a first turbine driving mechanism that is driven in conjunction with a first steam turbine to compress separated CO₂, a reheating boiler that supplies LP steam exhausted from the first steam turbine in order to heat the CO₂ absorption liquid, an auxiliary boiler that heats condensed water of the LP steam after the CO₂ absorption liquid is heated to generate HP steam and supplies the HP steam to the first steam turbine, and a second turbine driving mechanism that supplies the HP steam generated in the auxiliary boiler to a second steam turbine and is driven in conjunction with the second steam turbine.

### TECHNICAL FIELD

The present invention relates to a CO₂ recovery system and a CO₂ recovery method for recovering and removing CO₂ from an exhaust gas.

### BACKGROUND ART

In related art, as shown in FIG. 2, in a power generation facility 1 such as a thermal power plant, for example, fossil fuel such as coal, oil, or LNG is burned in a main boiler 2 to generate steam T1, and power generation is performed by turning turbines 3, 4 and 5 using this steam T1. Further, in such a thermal power plant, since a large amount of exhaust gas G which contains CO₂ that is one of greenhouse gases that is a contributing factor of global warming is exhausted with the combustion of the fossil fuel, a facility A for treating this exhaust gas G, particularly, recovering and removing CO₂ from the exhaust gas G, is provided.

Further, a system A that recovers this kind of CO₂ (a CO₂ recovery apparatus) includes, for example, a desulfurization cooling tower (a pre-treatment apparatus) 6 that performs pre-treatment of the exhaust gas G, an absorption tower (absorption apparatus) 8 that brings the exhaust gas G treated by the desulfurization cooling tower 6 to have a low temperature into contact with CO₂ absorption liquid (lean liquid) 7 and absorbs and removes CO₂ from the exhaust gas G, and a regeneration tower (regeneration apparatus) 10 that separates and recovers CO₂ from the CO₂ absorption liquid (rich liquid) 9 having absorbed CO₂ in the absorption tower 8 (e.g., see Patent Document 1).

Further, the CO₂ absorption liquid 9 after CO₂ has been recovered in the regeneration tower 10 is sent to the absorption tower 8 and used to absorb and remove CO₂ from the exhaust gas G again. In other words, this CO₂ recovery system A is configured to circulate the CO₂ absorption liquids 7 and 9 in an absorption liquid circulation path between the absorption tower 8 and the regeneration tower 10 and repeat the absorption of CO₂ into the CO₂ absorption liquid 7 and the recovery of CO₂ from the CO₂ absorption liquid 9 to recover and remove CO₂ from the exhaust gas G, which is sequentially supplied.

Meanwhile, CO₂ recovered in the regeneration tower 10 is treated as compressed CO₂ by the compressor 11 (a CO₂ compression mechanism 12). For example, compressed CO₂ is used as CO₂ for Enhanced Oil Recovery (EOR) technology for increasing the amount of collection of oil (crude oil) to increase the recovery rate of the oil, or is treated to be accumulated deep underground to prevent CO₂ from being released to the atmosphere and causing global warming.

Further, using an auxiliary boiler 13, high temperature and high pressure HP steam T1 supplied to a reheating boiler (a reboiler) 14 for heating the CO₂ absorption liquid 9 to separate and recover CO₂ in the regeneration tower 10, or HP steam T1 supplied to a steam turbine (a first steam turbine 15) for driving the compressor 11 that treats CO₂ recovered in the regeneration tower 10 as compressed CO₂ are generated. Further, the high temperature high-pressure HP steam T1 may be introduced from the main boiler 2 or the like of the power generation facility 1 to drive the steam turbine 15 of a large machine such as an exhaust gas blower or the CO₂ compressor 11, and LP steam T2 having a lower temperature and lower pressure than the HP steam T1 exhausted from the steam turbine 15 may be supplied to the reheating boiler 14.

### PRIOR ART DOCUMENT

### Patent Document

[Patent Document 1] Japanese Unexamined Patent Application, First Publication No. 2012-217903

### SUMMARY OF INVENTION

### Problems to be Solved by the Invention

However, when the HP steam T1 is introduced from the main boiler 2 or the like of the power generation facility 1 to drive the steam turbine 15 of the large machine such as the CO₂ compressor 11 and the LP steam T2 exhausted from the steam turbine 15 is supplied to the reheating boiler 14 as described above, appropriateness of driving of the steam turbine 15 is determined according to a condition of the HP steam T1, thereby causing significant restrictions. Further, when a small machine such as a pump is driven using a steam turbine, it is disadvantageous in terms of driving efficiency of the steam turbine, and accordingly, a machine to which steam driving can be applied is limited and effective use of the steam T1 is greatly limited.

Further, in order to stably operate the regeneration tower 10, it is necessary to keep pressure of an LP steam pipe header (an LP steam supply path 16) stable. However, the pressure of the LP steam T2 fluctuates under the influence of a load change of the power generation facility 1 and a condition change of the HP steam T2 of the main boiler 2. Accordingly, in the related art, as shown in FIG. 2, a let-down line (a let-down path) 18 is provided between an HP steam pipe header (an HP steam supply path 17) and the LP steam pipe header 16 to adjust the pressure of the LP steam pipe header 16 to be constant. However, extra HP steam T1 is consumed through the let-down line 18 since pressure control of the LP steam pipe header 16 is performed according to the load change of the power generation facility 1 as described above.

Further, since an HP steam consumption amount in the steam turbine (the first steam turbine 15 of the CO₂ compression mechanism 12) and an LP steam consumption amount in the reheating boiler 14 are not balanced, extra HP steam T1 is conventionally supplied to the reheating boiler 14 through the let-down line 18 to correspond to the LP steam consumption amount in the reheating boiler 14, as shown in FIG. 2. Accordingly, the extra HP steam T1 is let down to the LP steam T2 to correspond to the LP steam consumption amount in the reheating boiler 14, and energy of this HP steam T1 is not effectively utilized.

### Means for Solving the Problem

According to a first aspect of the present invention, a CO₂ recovery system includes an absorption apparatus that brings CO₂ absorption liquid into contact with an exhaust gas so that CO₂ in the exhaust gas is absorbed by the CO₂ absorption liquid; a regeneration apparatus that receives the CO₂ absorption liquid having absorbed CO₂ from the absorption apparatus and heats the CO₂ absorption liquid to separate CO₂ from the CO₂ absorption liquid; a CO₂ compression mechanism of a first turbine driving mechanism that is driven in conjunction with a first steam turbine to compress CO₂ separated in the regeneration apparatus; a reheating boiler that supplies LP steam exhausted from the first steam turbine in order to heat the CO₂ absorption liquid in the regeneration apparatus; an auxiliary boiler that heats condensed water of the LP steam after the CO₂ absorption liquid is heated to generate HP steam and supplies the HP steam to the first steam turbine of the CO₂ compression mechanism; and a second turbine driving mechanism that supplies the HP steam generated in the auxiliary boiler to a second steam turbine and is driven in conjunction with the second steam turbine.

In the CO₂ recovery system according to the first aspect of the present invention, the second turbine driving mechanism may be a power generator.

In the CO₂ recovery system according to the first aspect of the present invention, the first steam turbine and the second steam turbine may be configured of a single steam turbine, and the CO₂ compression mechanism of the first turbine driving mechanism and the second turbine driving mechanism may be configured to be driven in conjunction with the single steam turbine.

Further, in the CO₂ recovery system according to the first aspect of the present invention, a let-down path that connects an HP steam supply path that supplies HP steam from the auxiliary boiler to the first steam turbine and/or the second steam turbine, with an LP steam supply path that supplies LP steam from at least one of the first steam turbine and the second steam turbine to the reheating boiler may be provided, and an opening and closing valve that opens or closes the let-down path, and a pressure measurement mechanism that measures pressures of the HP steam supply path and the LP steam supply path, and controls opening and closing of the opening and closing valve with a difference between the pressures of the HP steam supply path and the LP steam supply path becoming a predetermined pressure difference may be provided.

Further, in the CO₂ recovery system according to the first aspect of the present invention, a let-down path that connects an HP steam supply path that supplies HP steam from the auxiliary boiler to the first steam turbine and/or the second steam turbine, with an LP steam supply path that supplies LP steam from at least one of the first steam turbine and the second steam turbine to the reheating boiler may be provided, and when an amount of steam necessary for the reheating boiler is R, an amount of steam necessary for driving of the CO₂ compression mechanism of the first turbine driving mechanism is C, an amount of steam generated in the auxiliary boiler is B, an amount of steam supplied to the second turbine driving mechanism is G, and a let-down steam amount to let down steam from the HP steam supply path to the LP steam supply path through the let-down path is L, B=C+G or B=C+G+L>R.

According to a second aspect of the present invention, a CO₂ recovery method is a method of recovering CO₂ from an exhaust gas, the method uses any one of the CO₂ recovery systems, the method includes: bringing, by the absorption apparatus, CO₂ absorption liquid into contact with the exhaust gas so that CO₂ in the exhaust gas is absorbed by the CO₂ absorption liquid; receiving, by the regeneration apparatus, the CO₂ absorption liquid treated by the absorption apparatus and heating the CO₂ absorption liquid to separate CO₂ from the CO₂ absorption liquid; compressing CO₂ separated in the regeneration apparatus by the CO₂ compression mechanism of the first turbine driving mechanism driven in conjunction with a first steam turbine; supplying LP steam exhausted from the first steam turbine to the reheating boiler so that the regeneration apparatus heats the CO₂ absorption liquid; heating, by the auxiliary boiler, condensed water of the LP steam after the CO₂ absorption liquid is heated to generate HP steam, supplying the HP steam to the first steam turbine of the CO₂ compression mechanism, and supply the HP steam to a second steam turbine so that a second turbine driving mechanism is driven in conjunction with the second steam turbine.

Further, in the CO₂ recovery method according to the second aspect of the present invention, the second turbine driving mechanism may be a power generator, and power generated in the power generator in conjunction with the second steam turbine may be used in the CO₂ recovery system.

Further, in the CO₂ recovery method according to the second aspect of the present invention, the first steam turbine and the second steam turbine may be configured of a single steam turbine, and the CO₂ compression mechanism of the first turbine driving mechanism and the second turbine driving mechanism may be driven in conjunction with the single steam turbine.

Further, in the CO₂ recovery method according to the second aspect of the present invention, the method may further include measuring, by a pressure measurement mechanism, pressures of the HP steam supply path and the LP steam supply path, and controlling opening and closing of the letdown path with a difference between the pressures of the HP steam supply path and the LP steam supply path becoming a predetermined pressure difference.

Further, in the CO₂ recovery method according to the second aspect of the present invention, when a steam amount necessary for the reheating boiler is R, an amount of steam necessary for driving of the CO₂ compression mechanism of the first turbine driving mechanism is C, an amount of steam generated in the auxiliary boiler is B, an amount of steam supplied to the second turbine driving mechanism is G, and an amount of let-down steam to let down steam from the HP steam supply path to the LP steam supply path through the let-down path is L, B=C+G or B=C+G+L>R.

### Effects of the Invention

In the CO₂ recovery system and the CO₂ recovery method described above, the HP steam can be generated by the auxiliary boiler using fuel such as natural gas. This HP steam can be used in a cogeneration system that is a combination of the steam turbine driven CO₂ compressor (the CO₂ compression mechanism of the first turbine driving mechanism) and the second turbine driving mechanism such as a steam turbine driven power generator. In other words, the CO₂ compressor mechanism can be driven in conjunction with the first steam turbine using the HP steam to compress CO₂, and the second turbine driving mechanism can be driven in conjunction with the second steam turbine to perform power generation or the like.

Accordingly, first, in the CO₂ recovery system and the CO₂ recovery method of the present embodiment, it is possible to generate the HP steam independently from the power generation facility by introducing the auxiliary boiler, and to perform a CO₂ recovery process irrespective of a condition and an influence of the HP steam on the power generation facility side (with an influence suppressed to be less).

Further, the first steam turbine or the second steam turbine can be driven using the HP steam generated in the auxiliary boiler. As the steam turbines are driven, CO₂ can be compressed by the CO₂ compression mechanism of the first turbine driving mechanism and the second turbine driving mechanism can be driven. Accordingly, for example, when a turbine-driven power generator is adopted in the second turbine driving mechanism to perform power generation, it is unnecessary to entirely receive power from the power generation facility and it is possible to supply power to all equipment used in the CO₂ recovery system.

Further, it is possible to control the pressure of the HP steam generated in the auxiliary boiler to be constant by adjusting a fuel flow rate of natural gas or the like supplied to the auxiliary boiler. Accordingly, the pressure of the HP steam supplied to the first steam turbine and the second steam turbine becomes constant and it is not necessary to let down (exhaust) the HP steam through the let-down path.

Further, the second turbine driving mechanism driven in conjunction with the second steam turbine using the HP steam is introduced and the LP steam exhausted from the second steam turbine is supplied to the reheating boiler. Accordingly, it is possible to balance the HP steam consumption amount and the LP steam consumption amount, and it is not necessary to let down the HP steam from this point.

### BRIEF DESCRIPTION OF DRAWINGS

FIG. 1 is a diagram illustrating a CO₂ recovery system (and a CO₂ recovery method) according to an embodiment of the present invention.

FIG. 2 is a diagram illustrating a CO₂ recovery system (and a CO₂ recovery method) of the related art.

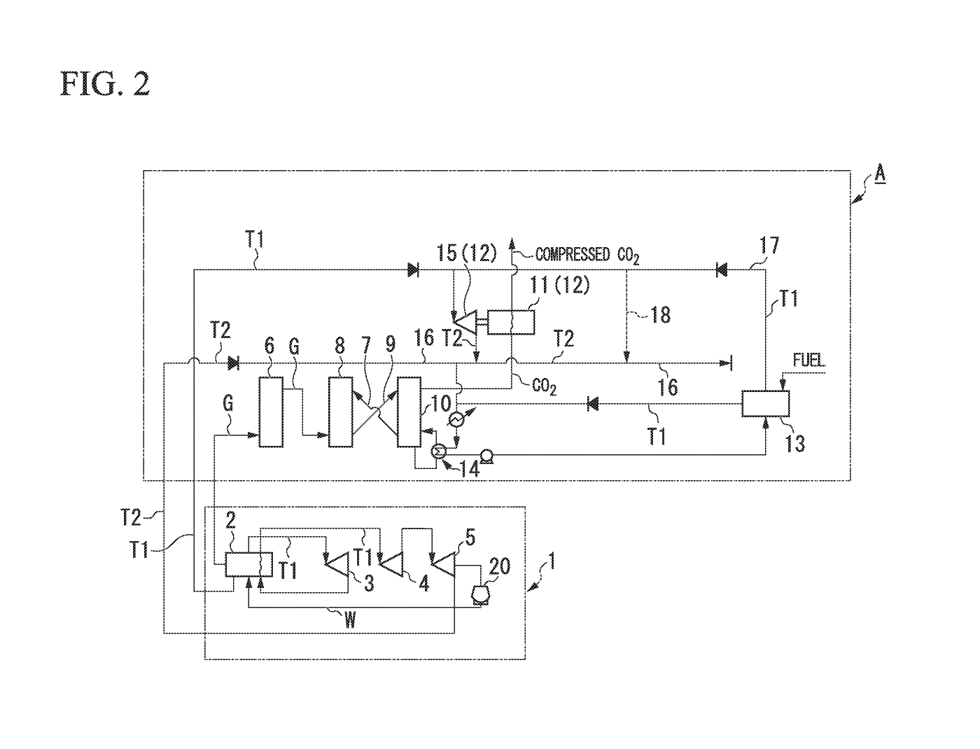

### MODES FOR CARRYING OUT THE INVENTION

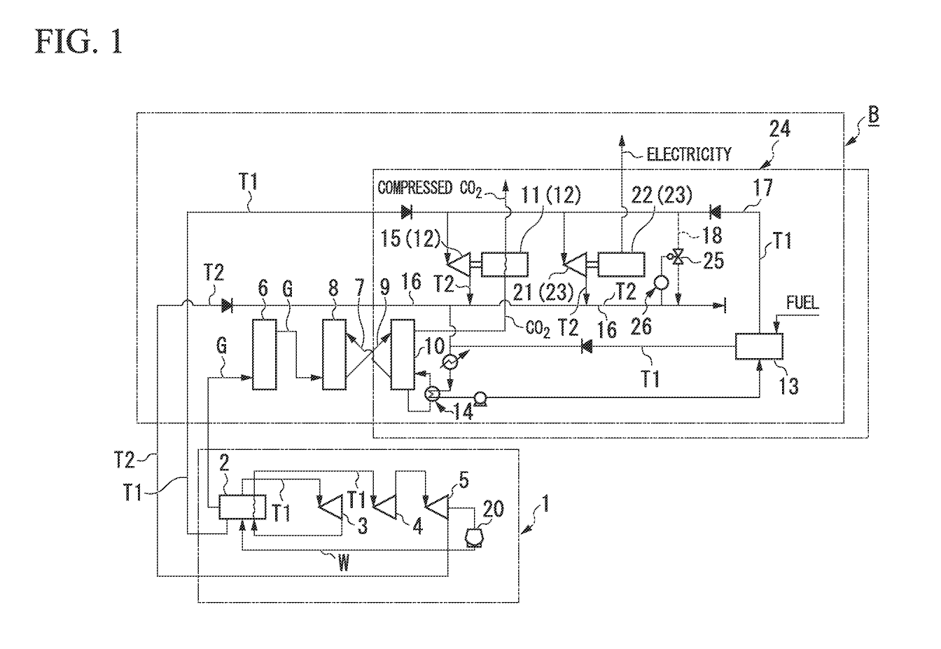

Hereinafter, a CO₂ recovery system and a CO₂ recovery method according to an embodiment of the present invention will be described with reference to FIG. 1.

Here, the CO₂ recovery system and the CO₂ recovery method of the present embodiment relate to a system for treating an exhaust gas from a main boiler that burns a large amount of fossil fuel such as coal, oil or LNG or from a turbine in a power generation facility such as a thermal power plant, and recovering CO₂ from the exhaust gas. Further, the CO₂ recovery system and the CO₂ recovery method according to the present invention need not be used for only treating of the exhaust gas generated in the thermal power plant, but may also be applied to other cases in which CO₂ is recovered and removed from an exhaust gas.

First, a CO₂ recovery system B of the present embodiment is a system for recovering and removing CO₂ in the exhaust gas G generated in the power generation facility 1, as shown in FIG. 1. For example, a high pressure turbine 3, an intermediate pressure turbine 4, a low pressure turbine 5, and a main boiler 2 that generates high temperature and high pressure HP steam T1 for driving the turbines are included in the power generation facility 1 in the present embodiment.

Here, the HP steam T1 generated in the main boiler 2 drives the high pressure turbine 3, and then is reheated as a high pressure turbine exhaust gas by a reheater (not shown) in the main boiler 2. This reheated moderate pressure steam (the HP steam T1) is sent to the intermediate pressure turbine 4 and the low pressure turbine 5 to drive the intermediate pressure turbine 4 and the low pressure turbine 5. Further, an exhaust gas from a low pressure turbine 5 is condensed by the condenser 20, and condensed water W generated by the condenser 20 is supplied to the main boiler 2 as a part of the boiler water.

Meanwhile, the CO₂ recovery system B of the present embodiment includes a desulfurization cooling tower (pre-treatment apparatus) 6 that receives an exhaust gas G generated by burning coal or the like in the main boiler 2, cools this exhaust gas G, and removes impurities such as sulfur oxide in the exhaust gas G, an absorption tower (an absorption apparatus) 8 that receives the exhaust gas G treated by the desulfurization cooling tower 6, brings the exhaust gas G into contact with CO₂ absorption liquid (lean liquid) 7 to remove CO₂ from the exhaust gas G, and a regeneration tower (a regeneration apparatus) 10 that receives and heats the CO₂ absorption liquid (rich liquid) 9 having absorbed CO₂ in the absorption tower and separates and recovers CO₂ absorbed by the CO₂ absorption liquid 9.

Further, the CO₂ recovery system B of the present embodiment includes a CO₂ compression mechanism 12 of the first turbine driving mechanism including a compressor 11 that compresses CO₂ separated and recovered in the regeneration tower 10 and a first steam turbine 15 for driving the compressor 11, and an auxiliary boiler 13 that generates HP steam T1 supplied to a reheating boiler (a re-boiler) 14 for separating and recovering CO₂ from the CO₂ absorption liquid 9 in the regeneration tower 10 or HP steam T1 for driving the first steam turbine 15 of the CO₂ compression mechanism 12.

In the desulfurization cooling tower 6, for example, the exhaust gas G from the main boiler 2 is introduced into a lower part and flows from the lower part to an upper part, and the treated exhaust gas G is supplied to the absorption tower 8 through a communication duct connected to the upper part. Further, the desulfurization cooling tower 6 includes a washing scrubber. Washing water is sprayed from the upper part to the inside of the desulfurization cooling tower 6 in a mist form by a pump. This washing water and the exhaust gas G are brought into contact with each other. Accordingly, gaseous toxic substances or the like in the exhaust gas G are dissolved in the washing water and trapped. Further, the washing water that has trapped the toxic substances or the like falls to and is accumulated in the lower part of the desulfurization cooling tower 6. Further, in the desulfurization cooling tower 6, the washing water accumulated in the lower part is pumped up by a pump and sprayed by the washing scrubber, and the exhaust gas G is pre-treated while circulating the washing water.

Further, a cooler that cools the water sprayed by the washing scrubber is provided. In order to increase efficiency when the CO₂ absorption liquid 7 is brought into contact with the exhaust gas G to absorb and remove CO₂ in the absorption tower 8 of a subsequent stage, the washing water is cooled by the cooler and the exhaust gas G is brought into contact with this washing water so that the temperature of the exhaust gas G is equal to or lower than a predetermined temperature. Further, in the desulfurization cooling tower 6, a demister is provided above the washing scrubber. The exhaust gas G treated by the washing scrubber passes through the demister, thereby removing the mist or the like.

In the absorption tower 8, the exhaust gas G pre-treated by the desulfurization cooling tower 6 is introduced into a lower part, flows from the lower part to an upper part, and is brought into contact with the CO₂ absorption liquid 7. Accordingly, CO₂ in the exhaust gas G is removed, and the exhaust gas G from which CO₂ has been removed is exhausted as a treated gas from the upper part to the outside.

Further, an absorption liquid scrubber that sprays the CO₂ absorption liquid (amine-based CO₂ absorption liquid) 7 in a mist form is provided in the absorption tower 8. The CO₂ absorption liquid 7 sprayed from the absorption liquid scrubber and the exhaust gas G flowing from the lower part to the upper part are brought into contact with each other. Accordingly, CO₂ in the exhaust gas G is dissolved in the CO₂ absorption liquid 7 and removed. Further, the CO₂ absorption liquid 9 that has absorbed CO₂ is accumulated in the lower part of the absorption tower 8.

For example, an amine-based absorption liquid may be adopted as the CO₂ absorption liquid 7. Specifically, an alkanolamine such as monoethanolamine, diethanolamine, triethanolamine, methyldiethanolamine, diisopropanolamine, or diglycolamine may be adopted. Further, hindered amines may be adopted as the CO₂ absorption liquid 7. Further, each water solution of the material or a water solution obtained by mixing two or more of the materials may be used as the CO₂ absorption liquid 7.

Further, in the absorption tower 8, a washing scrubber that sprays, in a mist form, the washing water cooled by the cooler and a pump is provided above the absorption liquid scrubber. Accordingly, impurities (containing toxic substances) in the exhaust gas G which have not been absorbed by the CO₂ absorption liquid 7 are trapped and removed by the washing water, the exhaust gas G whose temperature has risen in a CO₂ absorption unit is cooled, and moisture in the exhaust gas is condensed to prevent the CO₂ absorption liquid from being concentrated. Further, one or more pairs of demisters are provided above the absorption liquid scrubber and above and below the washing scrubber at intervals in a vertical direction. Mist in the exhaust gas G is removed by the demisters. Accordingly, a more reliably cleared exhaust gas G is exhausted to the outside.

Further, in the absorption tower 8, an absorption liquid transportation pipe for supplying the CO₂ absorption liquid 9 accumulated in the lower part to the regeneration tower 10 is connected to the lower part, and a liquid supply pump is provided in the absorption liquid transportation pipe. Further, an absorption liquid supply pipe that supplies the CO₂ absorption liquid 7 to the absorption liquid scrubber is connected to the absorption tower 8. Further, an absorption liquid circulation path through which the CO₂ absorption liquids 7 and 9 are circulated is formed of the absorption liquid transportation pipe, the absorption liquid supply pipe, the inside of the absorption tower 8, and the inside of the regeneration tower 10.

The regeneration tower 10 is intended to separate and recover CO₂ from the CO₂ absorption liquid 9 having absorbed CO₂ or the like in the absorption tower 8. An absorption liquid transportation pipe for introducing the CO₂ absorption liquid 9 from the absorption tower 8 is connected to an upper part of the regeneration tower 10. Further, the CO₂ absorption liquid 9 accumulated in the lower part of the absorption tower 8 is sprayed and supplied from the upper part side to the inside of the regeneration tower 10 by driving the liquid transportation pump of the absorption liquid transportation pipe.

Further, a reheating boiler 14 is provided in the regeneration tower 10. The sprayed CO₂ absorption liquid 9 is heated by the reheating boiler 14. Accordingly, CO₂ is dissociated from the CO₂ absorption liquid 9 to be desorbed, and desorbed CO₂ is derived from the upper part of the regeneration tower 10 to the outside.

The CO₂ absorption liquid 7 from which CO₂ has been dissociated and removed is accumulated in the lower part of the regeneration tower 10, and is sent to the absorption tower 8 by driving a return pump provided in the absorption liquid supply pipe. Further, in this case, the CO₂ absorption liquid 7 is cooled by the cooler and supplied to the absorption tower 8, sprayed from the absorption liquid scrubber to absorb CO₂ again, and accumulated in the lower part of the absorption tower 8.

In other words, the CO₂ absorption liquids 7 and 9 are circulated by the absorption liquid circulation path between the absorption tower 8 and the regeneration tower 10, the absorption of CO₂ into the CO₂ absorption liquid 7 and the recovery of the CO₂ from the CO₂ absorption liquid 9 are repeated, and CO₂ is recovered and removed from the exhaust gas G, which is sequentially supplied.

Meanwhile, CO₂ dissociated in the regeneration tower 10 is cooled by the cooler, compressed by the compressor 11 of the CO₂ compression mechanism 12 of the first turbine driving mechanism, and treated. Moisture generated by treating CO₂ is returned to the regeneration tower 10.

Further, in the CO₂ compression mechanism 12 that is the first turbine driving mechanism of the present embodiment, for example, the HP steam T1 generated by the auxiliary boiler 13 using natural gas as fuel is sent to the first steam turbine 15, and the compressor 11 is driven in conjunction with turn-driving of the first steam turbine 15 to compress CO₂. Further, the LP steam T2 exhausted from the first steam turbine 15 is sent to the reheating boiler 14 through the LP steam supply path 16 and cooled by the reheating boiler 14, and the condensed condensation water is sent to the auxiliary boiler 13 to be the HP steam T1 again, and supplied to the first steam turbine 15 through the HP steam supply path 17.

Further, in the CO₂ recovery system B (and the CO₂ recovery method) of the present embodiment, the HP steam T1 generated by the auxiliary boiler 13 is used in the cogeneration system 24 that is a combination of the first turbine driving mechanism 12 including the compressor 11 driven in conjunction with the first steam turbine 15 and the second turbine driving mechanism 23 including the power generator 22 driven in conjunction with the second steam turbine 21.

In other words, using the HP steam T1, the first steam turbine 15 of the CO₂ compression mechanism 12 that is the first turbine driving mechanism is driven to compress CO₂, and also, the second steam turbine 21 that drives the power generator 22 of the second turbine driving mechanism 23 is driven to perform the power generation. Further, in the present embodiment, the power generated by the power generator 22 is supplied to power-driven facility equipment of the CO₂ recovery system B other than the CO₂ compressor 11. Further, the LP steam T2 exhausted from each of the first steam turbine 15 that drives the CO₂ compressor 11 and the second steam turbine 21 that drives power generator 22 is supplied to the reheating boiler 14 through the LP steam supply path 16.

Thus, in the CO₂ recovery system B and the CO₂ recovery method of the present embodiment, the HP steam T1 can be generated independently from the power generation facility 1 by introducing the auxiliary boiler 13. Further, the power generation can be performed by driving the first steam turbine 15 and the second steam turbine 21 using the HP steam T1 generated by the auxiliary boiler 13 and driving the power generator 22 in conjunction with the second steam turbine 21. Further, it is not necessary to receive the electricity from the power generation facility 1, for example, by using the electricity generated by the power generator 22.

When the CO₂ recovery system B of the present embodiment is cogeneration-driven (controlled) as described above, the pressure of the HP steam pipe header (the HP steam supply path 17) is controlled by controlling the flow rate of the fuel such as the natural gas supplied to the auxiliary boiler 13. Further, in the present embodiment, in this case, a control valve (an opening and closing valve) 25 is provided on the let-down line (a let-down path) 18. A pressure measurement mechanism 26 that measures pressures of the HP steam pipe header 17 and the LP steam pipe header 16 and controls opening and closing of the control valve 25 with a difference between the pressures of the HP steam pipe header 17 and the LP steam pipe header 16 becoming a previously set pressure difference is provided. The pressure of the LP steam pipe header 16 is controlled by controlling the inflow rate of the HP steam T1. Further, a steam flow rate of the respective steam turbines 15 and 21 for driving the CO₂ compressor 11 and the power generator 22 is controlled by controlling an output balance of the CO₂ compressor 11 and the power generator 22.

Thus, the pressure of the HP steam T1 supplied to the first steam turbine 15 and the second steam turbine 21 becomes constant, and it is not necessary to let down the HP steam T1 through the let-down line 18. Further, the HP steam consumption amount and the LP steam consumption amount are balanced, and accordingly it is not necessary to let out the HP steam T1.

Further, when extra LP steam T2 is generated at the time of turndown, it is desirable to supply the extra LP steam T2 to an LP steam cooler with pressure balance of the LP steam pipe header 16.

Here, the cogeneration system 24 (cogeneration operation) in the CO₂ recovery system 13 of the present embodiment will be described in greater detail.

First, it is assumed that a steam amount necessary for the reheating boiler 14 is R, a steam amount necessary for driving the CO₂ compressor 11 is C, the amount of steam generated in the auxiliary boiler 13 is B, the amount of steam supplied to drive the power generator is G, and the amount of let-out steam is L.

In the CO₂ recovery system A of the related art, when the amount of steam R necessary in the reheating boiler is equal to 10 and the amount of steam C necessary for the compressor is equal to 5, the amount of steam B generated in the auxiliary boiler is equal to 10 and a remainder, i.e., the amount of let-down steam L, is equal to 5 for let-down, but the steam T1 of the main boiler 2 needed to be 5. In other words, B=R=C+L was necessary.

In contrast, in the CO₂ recovery system B and the CO₂ recovery method of the present embodiment, when the amount of steam R necessary for the reheating boiler is equal to 10 and the amount of steam C necessary for the compressor is equal to 5, the amount of steam B generated in the auxiliary boiler is equal to 10 and the amount of steam G supplied to drive the power generator is equal to 5 on balance and the steam T1 from the main boiler 2 is zero. Alternatively, for example, the amount of let-down steam L is minimized by the amount of steam R necessary for the reheating boiler being equal to 11 and the amount of let-down steam L being equal to 1. In other words, B=C+G or B=C+G+L>R.

In this case, since C>R by all means, it is possible to determine the capacity of the power generator 22 by assuming R−C=G. Further, when power necessary for the CO₂ recovery system B is supplied and extra power is generated, the power may be output to the outside and sold to the power generation facility 1. Further, when each of the HP steam (amount of let-down steam L1) and the LP steam (amount of let-down steam L2) is let down for pressure control, the capacity B of the auxiliary boiler 13 may be determined as B=C+G+L1 by setting R+L2−(C+L1)=G.

Accordingly, in the CO₂ recovery system B and the CO₂ recovery method of the present embodiment, the HP steam T1 can be generated by the auxiliary boiler 13 using fuel such as natural gas and this HP steam T1 can be used in the cogeneration system 24 that is a combination of the steam turbine driven CO₂ compressor 11 (the CO₂ compression mechanism 12 of the first turbine driving mechanism) and the second turbine driving mechanism 23 such as the steam turbine driven power generator 22. In other words, using the HP steam T1, the CO₂ compressor 11 (the CO₂ compression mechanism 12) can be driven in conjunction with the first steam turbine 15 to perform CO₂ compression treatment and the second turbine driving mechanism 23 can be driven in conjunction with the second steam turbine 21 to perform power generation or the like.

Accordingly, first, in the CO₂ recovery system B and the CO₂ recovery method of the present embodiment, it is possible to generate the HP steam T1 independently from the power generation facility 1 by introducing the auxiliary boiler 13, and to perform the CO₂ recovery process irrespective of a condition and an influence of the HP steam T1 on the power generation facility side (with an influence suppressed to be less).

Further, for example, it is not necessary to entirely receive electricity from the power generation facility 1 and it is possible to supply power to all equipment used in the CO₂ recovery system B by adopting the turbine driven power generator 22 in the second turbine driving mechanism 23 to generation electricity and using electricity. Further, power generation efficiency of the power generation facility 1 is not degraded by introducing the CO₂ recovery system 13 not to use the steam from the power generation facility 1.

Further, when the condensed water generated in the desulfurization cooling tower 6 or the absorption tower 8 of the CO₂ recovery system B is used as boiler water of the auxiliary boiler 13, it is possible to effectively generate the HP steam T1 in the auxiliary boiler 13 by separately supplying only fuel such as natural gas to the auxiliary boiler 13.

It is also possible to control the pressure of the HP steam T1 generated in the auxiliary boiler 13 to be constant by adjusting a fuel flow rate of the natural gas or the like supplied to the auxiliary boiler 13. Accordingly, the pressure of the HP steam T1 supplied to the first steam turbine 15 and the second steam turbine 21 becomes constant, and it is not necessary to vainly let down the HP steam T1 through the let-down line 18.

Further, the second turbine driving mechanism 23 driven in conjunction with the second steam turbine 21 using the HP steam T1 is introduced, and the LP steam T2 exhausted from the second steam turbine 21 is supplied to the reheating boiler 14. Accordingly, it is possible to balance the amount of HP steam consumed and the amount of LP steam consumed, thus, it is not necessary to let down the HP steam T1 from this point.

While the embodiments of the CO₂ recovery system and the CO₂ recovery method according to the present invention have been described, the present invention is not limited to the embodiments and may be appropriately modified without departing from the scope and spirit of the present invention.

For example, in the present embodiment, while the first steam turbine 15 of the CO₂ compression mechanism 12 of the first turbine driving mechanism and the second steam turbine 21 that drives the power generator 22 of the second turbine driving mechanism 23 have been described as individual steam turbines, the first steam turbine 15 and the second steam turbine 21 may be configured of a single steam turbine, and the CO₂ compression mechanism 12 of the first turbine driving mechanism and the second turbine driving mechanism 23 may be driven in conjunction with the single steam turbine.

Further, in this case, it is possible to constitute the CO₂ recovery system B compactly and economically, to reduce an amount of steam generated by the auxiliary boiler 13, and to increase the use efficiency of the steam T1.

Further, in the present embodiment, while the second turbine driving mechanism 23 driven in conjunction with the second steam turbine 21 includes the power generator 22 (is the power generator 22), the second turbine driving mechanism 23 driven in conjunction with the second steam turbine 21 need not be particularly limited to the mechanism including the power generator 22 as long as the mechanism is equipment that can be driven in conjunction with the steam turbine 21, such as a blower or a pump. Further, the CO₂ recovery system B may include a plurality of pieces of equipment such as the power generator 22 and the pump as the second turbine driving mechanism 23. In this case, the second turbine driving mechanisms 23 of a plurality of pieces of equipment may be driven in conjunction with one second steam turbine 21, or a plurality of second steam turbines 21 may be included and the second turbine driving mechanisms 23 of a plurality of pieces of equipment may be driven by the respective second steam turbines 21.

### INDUSTRIAL APPLICABILITY

In the CO₂ recovery system and the CO₂ recovery method described above, the HP steam can be generated in the auxiliary boiler using fuel such as the natural gas, and this HP steam can be used in the cogeneration system that is the combination of the steam turbine driven CO₂ compressor (the CO₂ compression mechanism of the first turbine driving mechanism) and the second turbine driving mechanism such as the steam turbine driven power generator. In other words, using the HP steam, the CO₂ compressor mechanism can be driven in conjunction with the first steam turbine to perform a CO₂ compression process and the second turbine driving mechanism can be driven in conjunction with the second steam turbine to perform power generation or the like.

### REFERENCE SIGNS LIST

1 power generation facility
2 main boiler
3 high pressure turbine
4 intermediate pressure turbine
5 low pressure turbine
6 desulfurization cooling tower (pre-treatment apparatus)
7 CO₂ absorption liquid (lean liquid)
8 absorption tower (absorption apparatus)
9 CO₂ absorption liquid (rich liquid)
10 regeneration tower (regeneration apparatus)
11 compressor
12 CO₂ compression mechanism (first turbine driving mechanism)
13 auxiliary boiler
14 reheating boiler (re-boiler)
15 first steam turbine
16 LP steam pipe header (LP steam supply path)
17 HP steam pipe header (HP steam supply path)
18 let-down line (let-down path)
20 condenser
21 second steam turbine
22 power generator
23 second turbine driving mechanism
24 cogeneration system
25 control valve (opening and closing valve)
26 pressure measurement mechanism
A CO₂ recovery system of related art
B CO₂ recovery system
G exhaust gas
T1 HP steam
T2 LP steam
W condensed water

1. A CO₂ recovery system comprising:
an absorption apparatus that brings CO₂ absorption liquid into contact with an exhaust gas so that CO₂ in the exhaust gas is absorbed by the CO₂ absorption liquid;
a regeneration apparatus that receives the CO₂ absorption liquid having absorbed CO₂ from the absorption apparatus and heats the CO₂ absorption liquid to separate CO₂ from the CO₂ absorption liquid;
a CO₂ compression mechanism of a first turbine driving mechanism that is driven in conjunction with a first steam turbine to compress CO₂ separated in the regeneration apparatus;
a reheating boiler that supplies LP steam exhausted from the first steam turbine in order to heat the CO₂ absorption liquid in the regeneration apparatus;
an auxiliary boiler that heats condensed water of the LP steam after the CO₂ absorption liquid is heated to generate HP steam and supplies the HP steam to the first steam turbine of the CO₂ compression mechanism; and
a second turbine driving mechanism that supplies the HP steam generated in the auxiliary boiler to a second steam turbine and is driven in conjunction with the second steam turbine.

2. The CO₂ recovery system according to claim 1, wherein the second turbine driving mechanism is a power generator.

3. The CO₂ recovery system according to claim 1, wherein the first steam turbine and the second steam turbine are configured of a single steam turbine, and the CO₂ compression mechanism of the first turbine driving mechanism and the second turbine driving mechanism are configured to be driven in conjunction with the single steam turbine.

4. The CO₂ recovery system according to claim 1, wherein:
a let-down path that connects an HP steam supply path that supplies HP steam from the auxiliary boiler to the first steam turbine and/or the second steam turbine, with an LP steam supply path that supplies LP steam from at least one of the first steam turbine and the second steam turbine to the reheating boiler is provided, and
an opening and closing valve that opens or closes the let-down path, and a pressure measurement mechanism that measures pressures of the HP steam supply path and the LP steam supply path, and controls opening and closing of the opening and closing valve as a difference between the pressures of the HP steam supply path and the LP steam supply path becoming a predetermined pressure difference are provided.

5. The CO₂ recovery system according to claim 1, wherein:
a let-down path that connects an HP steam supply path that supplies HP steam from the auxiliary boiler to the first steam turbine and/or the second steam turbine, with an LP steam supply path that supplies LP steam from at least one of the first steam turbine and the second steam turbine to the reheating boiler is provided, and
when a steam amount necessary for the reheating boiler is R, an amount of steam necessary for driving of the CO₂ compression mechanism of the first turbine driving mechanism is C, an amount of steam generated in the auxiliary boiler is B, an amount of steam supplied to the second turbine driving mechanism is G, and an amount of let-down steam to let down steam from the HP steam supply path to the LP steam supply path through the let-down path is L, B=C+G or B=C+G+L>R.

6. A method of recovering CO₂ from an exhaust gas, the method using the CO₂ recovery system according to claim 1, the method comprising:
bringing, by the absorption apparatus, CO₂ absorption liquid into contact with the exhaust gas so that CO₂ in the exhaust gas is absorbed by the CO₂ absorption liquid;
receiving, by the regeneration apparatus, the CO₂ absorption liquid treated by the absorption apparatus and heating the CO₂ absorption liquid to separate CO₂ from the CO₂ absorption liquid;
compressing CO₂ separated in the regeneration apparatus by the CO₂ compression mechanism of the first turbine driving mechanism driven in conjunction with a first steam turbine;
supplying LP steam exhausted from the first steam turbine to the reheating boiler so that the regeneration apparatus heats the CO₂ absorption liquid;
heating, by the auxiliary boiler, condensed water of the LP steam after the CO₂ absorption liquid is heated to generate HP steam, supplying the HP steam to the first steam turbine of the CO₂ compression mechanism and to a second steam turbine so that a second turbine driving mechanism is driven in conjunction with the second steam turbine.

7. The CO₂ recovery method according to claim 6, wherein the second turbine driving mechanism is a power generator, and power generated in the power generator in conjunction with the second steam turbine is used in the CO₂ recovery system.

8. The CO₂ recovery method according to claim 6, wherein the first steam turbine and the second steam turbine are configured of a single steam turbine, and the CO₂ compression mechanism of the first turbine driving mechanism and the second turbine driving mechanism are driven in conjunction with the single steam turbine.

9. The CO₂ recovery method according to claim 6, further comprising:
measuring, by a pressure measurement mechanism, pressures of the HP steam supply path and the LP steam supply path, and controlling opening and closing of the let-down path as a difference between the pressures of the HP steam supply path and the LP steam supply path becoming a predetermined pressure difference.

10. The CO₂ recovery method according to claim 6, wherein:
when a steam amount necessary for the reheating boiler is R, an amount of steam necessary for driving of the CO₂ compression mechanism of the first turbine driving mechanism is C, an amount of steam generated in the auxiliary boiler is B, an amount of steam supplied to the second turbine driving mechanism is G, and an amount of let-down steam to let down steam from the HP steam supply path to the LP steam supply path through the let-down path is L, B=C+G or B=C+G+L>R.

11. A method of recovering CO₂ from an exhaust gas, the method using the CO₂ recovery system according to claim 2, the method comprising:
bringing, by the absorption apparatus, CO₂ absorption liquid into contact with the exhaust gas so that CO₂ in the exhaust gas is absorbed by the CO₂ absorption liquid;
receiving, by the regeneration apparatus, the CO₂ absorption liquid treated by the absorption apparatus and heating the CO₂ absorption liquid to separate CO₂ from the CO₂ absorption liquid;
compressing CO₂ separated in the regeneration apparatus by the CO₂ compression mechanism of the first turbine driving mechanism driven in conjunction with a first steam turbine;
supplying LP steam exhausted from the first steam turbine to the reheating boiler so that the regeneration apparatus heats the CO₂ absorption liquid;
heating, by the auxiliary boiler, condensed water of the LP steam after the CO₂ absorption liquid is heated to generate HP steam, supplying the HP steam to the first steam turbine of the CO₂ compression mechanism and to a second steam turbine so that a second turbine driving mechanism is driven in conjunction with the second steam turbine.

12. A method of recovering CO₂ from an exhaust gas, the method using the CO₂ recovery system according to claim 3, the method comprising:
bringing, by the absorption apparatus, CO₂ absorption liquid into contact with the exhaust gas so that CO₂ in the exhaust gas is absorbed by the CO₂ absorption liquid;
receiving, by the regeneration apparatus, the CO₂ absorption liquid treated by the absorption apparatus and heating the CO₂ absorption liquid to separate CO₂ from the CO₂ absorption liquid;
compressing CO₂ separated in the regeneration apparatus by the CO₂ compression mechanism of the first turbine driving mechanism driven in conjunction with a first steam turbine;
supplying LP steam exhausted from the first steam turbine to the reheating boiler so that the regeneration apparatus heats the CO₂ absorption liquid;
heating, by the auxiliary boiler, condensed water of the LP steam after the CO₂ absorption liquid is heated to generate HP steam, supplying the HP steam to the first steam turbine of the CO₂ compression mechanism and to a second steam turbine so that a second turbine driving mechanism is driven in conjunction with the second steam turbine.

13. A method of recovering CO₂ from an exhaust gas, the method using the CO₂ recovery system according to claim 4, the method comprising:
bringing, by the absorption apparatus, CO₂ absorption liquid into contact with the exhaust gas so that CO₂ in the exhaust gas is absorbed by the CO₂ absorption liquid;
receiving, by the regeneration apparatus, the CO₂ absorption liquid treated by the absorption apparatus and heating the CO₂ absorption liquid to separate CO₂ from the CO₂ absorption liquid;
compressing CO₂ separated in the regeneration apparatus by the CO₂ compression mechanism of the first turbine driving mechanism driven in conjunction with a first steam turbine;
supplying LP steam exhausted from the first steam turbine to the reheating boiler so that the regeneration apparatus heats the CO₂ absorption liquid;
heating, by the auxiliary boiler, condensed water of the LP steam after the CO₂ absorption liquid is heated to generate HP steam, supplying the HP steam to the first steam turbine of the CO₂ compression mechanism and to a second steam turbine so that a second turbine driving mechanism is driven in conjunction with the second steam turbine.

14. A method of recovering CO₂ from an exhaust gas, the method using the CO₂ recovery system according to claim 5, the method comprising:
bringing, by the absorption apparatus, CO₂ absorption liquid into contact with the exhaust gas so that CO₂ in the exhaust gas is absorbed by the CO₂ absorption liquid;
receiving, by the regeneration apparatus, the CO₂ absorption liquid treated by the absorption apparatus and heating the CO₂ absorption liquid to separate CO₂ from the CO₂ absorption liquid;
compressing CO₂ separated in the regeneration apparatus by the CO₂ compression mechanism of the first turbine driving mechanism driven in conjunction with a first steam turbine;
supplying LP steam exhausted from the first steam turbine to the reheating boiler so that the regeneration apparatus heats the CO₂ absorption liquid;
heating, by the auxiliary boiler, condensed water of the LP steam after the CO₂ absorption liquid is heated to generate HP steam, supplying the HP steam to the first steam turbine of the CO₂ compression mechanism and to a second steam turbine so that a second turbine driving mechanism is driven in conjunction with the second steam turbine.
